(19) United States
(12) Patent Application Publication
(10) Pub. No.: US 2016/0112889 A1
(43) Pub. Date: Apr. 21, 2016

(54) APPARATUS AND METHOD FOR COMMUNICATION OF BASE STATION FOR MU-MIMO TRANSMISSION AND RECEPTION IN DISTRIBUTED ANTENNA SYSTEM

(71) Applicant: Electronics and Telecommunications Research Institute, Daejeon (KR)

(72) Inventors: Young Jin MOON, Daejeon (KR); Jun-Woo KIM, Daejeon (KR); Youn Ok PARK, Daejeon (KR); Seungjae BAHNG, Daejeon (KR)

(21) Appl. No.: 14/887,646

(22) Filed: Oct. 20, 2015

(30) Foreign Application Priority Data
Oct. 20, 2014 (KR) 10-2014-0142035

(51) Int. Cl. H04W 24/08; H04B 7/04

(52) U.S. Cl. CPC H04W 24/08; H04B 7/0452

(57) ABSTRACT

A base station acquires an arrival time at which a signal that is transmitted from a plurality of terminals arrives at a plurality of Remote Radio Heads (RRH) that are installed within a cell, calculates an arrival delay time between the plurality of terminals and the plurality of RRHs using a predetermined reference time and an arrival time of the plurality of RRHs, selects RRHs to participate in receiving the uplink MU-MIMO among the plurality of RRHs using an arrival delay time between the plurality of terminals and the plurality of RRHs, and adjusts a transmitting time of the plurality of terminals using an arrival delay time between the plurality of terminals and RRHs to participate in receiving the uplink MU-MIMO.

### CROSS-REFERENCE TO RELATED APPLICATION

This application claims priority to and the benefit of Korean Patent Application No. 10-2014-0142035 filed in the Korean Intellectual Property Office on Oct. 20, 2014, the entire contents of which are incorporated herein by reference.

### BACKGROUND OF THE INVENTION

(a) Field of the Invention

The present invention relates to an apparatus and method for communication of a base station for multiple user-multiple input multiple output in a distributed antenna system. More particularly, the present invention relates to an apparatus and method for communication of a base station for improving a receiving performance gain of multiple user multiple antenna transmission in an uplink direction in a distributed antenna system.

(b) Description of the Related Art

A distributed antenna system in consideration of one of technology for maximizing average cell spectrum efficiency and maximum data transmission speed through cooperation communication is a system in which a plurality of low power Remote Radio Heads (RRH) are distributed and connected through an optic cable to be integrated and managed in a cell area of a base station.

In the distributed antenna system, a plurality of RRHs are used as receiving points of a signal that is transmitted from one terminal in an uplink direction to obtain an optimal cooperation communication reception gain. Particularly, when using a plurality of terminals and a plurality of RRHs as transmitting and receiving points, there is a merit that an uplink MU-MIMO for maximizing average cell spectrum efficiency and maximum data transmission speed in an uplink direction can be used.

However, in order to actively use an uplink MU-MIMO, a performance degradation problem due to an independent receiving delay time difference occurring through a radio channel between a plurality of terminals and a plurality of RRHs should be considered. When a plurality of RRHs use a signal that is transmitted from a terminal as a receiving point, one of a plurality of RRHs may be determined as an anchor RRH and a transmitting time point of a terminal may be adjusted based on a receiving delay time of an anchor RRH, but there is a problem that a receiving delay time of non-anchor RRHs cannot entirely equally correspond. Due to a receiving delay time difference between a plurality of terminals and a plurality of RRHs due to such a problem, degradation of receiving performance of an uplink MU-MIMO may occur.

Particularly, in an uplink LTE-A MU-MIMO, because each Demodulated Reference Signal (DMRS) that is transmitted from a plurality of terminals has a characteristic that it shares a frequency resource and a time resource and that it distinguishes a code with only Cyclic Shift (CS) and Orthogonal Cover Code (OCC), a receiving delay time difference between terminals may have a serious influence on receiving performance of an MU-MIMO.

### SUMMARY OF THE INVENTION

The present invention has been made in an effort to provide an apparatus and method for communication of a base station for multiple user-multiple input multiple output (MU-MIMO) in a distributed antenna system that can improve a receiving performance gain of an uplink MU-MIMO in a distributed antenna system.

An exemplary embodiment of the present invention provides a method in which a base station that is connected to a plurality of Remote Radio Heads (RRH) that are installed within a cell performs uplink multiple user-multiple input multiple output (MU-MIMO) communication with a plurality of terminals. The method includes: acquiring an arrival time at which a signal that is transmitted from the plurality of terminals arrives at the plurality of RRHs; calculating an arrival delay time between the plurality of terminals and the plurality of RRHs using a predetermined reference time and an arrival time of the plurality of RRHs; selecting RRHs to participate in receiving the uplink MU-MIMO among the plurality of RRHs using an arrival delay time between the plurality of terminals and the plurality of RRHs; and adjusting a transmitting time of the plurality of terminals using an arrival delay time between the plurality of terminals and RRHs to participate in receiving the uplink MU-MIMO.

The selecting of RRHs may include: calculating a plurality of first arrival delay time differences between the same terminal and different RRHs using an arrival delay time between the plurality of terminals and the plurality of RRHs; selecting a first number of RRHs among the plurality of first arrival delay time differences; calculating a plurality of second arrival delay time differences between different terminals and the same RRH and a plurality of third arrival delay time differences between different terminals and different RRHs using an arrival delay time between the plurality of terminals and the first number of RRHs; and selecting a second number of RRHs to participate in receiving the uplink MU-MIMO using the plurality of second arrival delay time differences and the plurality of third arrival delay time differences.

The selecting of the first number of RRHs may include selecting the first number of RRHs having a small value among the plurality of first arrival delay time differences.

The selecting of the second number of RRHs may include selecting the second number of RRHs in which the sum of a second arrival delay time difference and a third arrival delay time difference is small for each of the first number of RRHs.

The adjusting of a transmitting time may include: calculating a first minimum arrival delay time between the first number of RRHs for each terminal using an arrival delay time between the same terminal and the first number of selected RRHs; calculating a second minimum arrival delay time between the second number of RRHs for each terminal using an arrival delay time between the same terminal and the second number of selected RRHs; and determining a transmitting time of each terminal using the calculated first minimum arrival time for each terminal and the calculated second minimum arrival delay time for each terminal.

The determining of a transmitting time may include determining a transmitting time of each terminal from the sum of a first minimum arrival time corresponding to each terminal and a second minimum arrival time corresponding to each terminal.

The adjusting of a transmitting time may further include transmitting a transmitting time of each terminal to each terminal.

Another embodiment of the present invention provides an apparatus that enables a base station that is connected to a plurality of Remote Radio Heads (RRH) that are installed within a cell to perform uplink multiple user-multiple input multiple output (MU-MIMO) communication with a plurality of terminals. The communication apparatus includes a processor and a transceiver. The processor acquires an arrival time at which a signal that is transmitted from the plurality of terminals arrives at the plurality of RRHs, calculates an arrival delay time between the plurality of terminals and the plurality of RRHs using a predetermined reference time and an arrival time of the plurality of RRHs, and selects RRHs to participate in receiving an uplink MU-MIMO using an arrival delay time between the plurality of terminals and the plurality of RRHs. The transceiver includes the plurality of RRHs and receives a signal that is transmitted from the plurality of terminals through the plurality of RRHs.

The processor may calculate a plurality of first arrival delay time differences between the same terminal and different RRHs using an arrival delay time between the plurality of terminals and the plurality of RRHs to select a first number of RRHs, and calculate a plurality of second arrival delay time differences between different terminals and the same RRH and a plurality of third arrival delay time differences between different terminals and different RRHs using an arrival delay time between the plurality of terminals and the first number of RRHs to select a second number of RRHs to participate in receiving the uplink MU-MIMO.

The processor may select the first number of RRHs having a small value among a plurality of first arrival delay time differences.

The processor may select the second number of RRHs in which the sum of a second arrival delay time difference and a third arrival delay time difference is small for each of the first number of RRHs.

The processor may determine a transmitting time of the plurality of terminals using an arrival delay time between the plurality of terminals and RRHs to participate in receiving the uplink MU-MIMO.

The processor may calculate a first minimum arrival delay time between the first number of RRHs for each terminal using an arrival delay time between the same terminal and the first number of selected RRHs, calculate a second minimum arrival delay time between the second number of RRHs for each terminal using an arrival delay time between the same terminal and the second number of selected RRHs, and determine a transmitting time of each terminal using the calculated first minimum arrival time for each terminal and using the calculated second minimum arrival time for each terminal.

The processor may determine a transmitting time of each terminal from the sum of a first minimum arrival time corresponding to each terminal and a second minimum arrival time corresponding to each terminal.

### BRIEF DESCRIPTION OF THE DRAWINGS

FIG. 1 is a diagram illustrating a distributed antenna system according to an exemplary embodiment of the present invention.

FIG. 2 is a diagram illustrating an uplink MU-MIMO according to an exemplary embodiment of the present invention.

FIG. 3 is a graph illustrating a simulation result of a BER to an SNR according to an arrival delay time difference between terminals and RRHs.

FIG. 4 is a graph illustrating receiving performance according to a relative arrival delay time difference between terminals in each RRH.

FIG. 5 is a diagram illustrating a kind of an arrival delay time difference in an uplink MU-MIMO according to an exemplary embodiment of the present invention.

FIGS. 6A and 6B are diagrams illustrating a method of selecting an RRH to participate in receiving an uplink MU-MIMO according to an exemplary embodiment of the present invention.

FIG. 7 is a flowchart illustrating a method of selecting an RRH to participate in receiving an uplink MU-MIMO and a method of adjusting a transmitting time of a terminal according to an exemplary embodiment of the present invention.

FIG. 8 is a graph illustrating receiving performance of an uplink MU-MIMO by a method of selecting an RRH and a method of adjusting a transmitting time of a terminal according to an exemplary embodiment of the present invention.

FIG. 9 is a block diagram illustrating a configuration of a communication apparatus of a base station according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in an entire specification and claims, unless explicitly described to the contrary, the word “comprise” and variations such as “comprises” or “comprising” will be understood to imply the inclusion of stated elements but not the exclusion of any other elements. In addition, the terms “-er”, “-or”, “module”, and “block” described in the specification mean units for processing at least one function and operation and can be implemented by hardware components or software components and combinations thereof.

In an entire specification, a terminal may indicate a mobile terminal (MT), a mobile station (MS), an advanced mobile station (AMS), a high reliability mobile station (HR-MS), a subscriber station (SS), a portable subscriber station (PSS), an access terminal (AT), and user equipment (UE), and may include an entire function or a partial function of the MT, the MS, the AMS, the HR-MS, the SS, the PSS, the AT, and the UE.

Further, a base station (BS) may indicate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) that performs a BS function, a relay node (RN) that performs a BS function, an advanced relay station (ARS) that performs a BS function, a high reliability relay station (HR-RS) that performs a BS function, and a small BS [a femto BS, a home node B(HNB), a home eNodeB (HeNB), a pico BS, a metro BS, and a micro BS], and may include an entire function or a partial function of the ABS, the nodeB, the eNodeB, the AP, the RAS, the BTS, the MMR-BS, the RS, the RN, the ARS, the HR-RS, and the small BS.

Hereinafter, an apparatus and method for communication of a base station for multiple user multiple antenna transmission in a distributed antenna system according to an exemplary embodiment of the present invention will be described in detail with reference to the drawings.

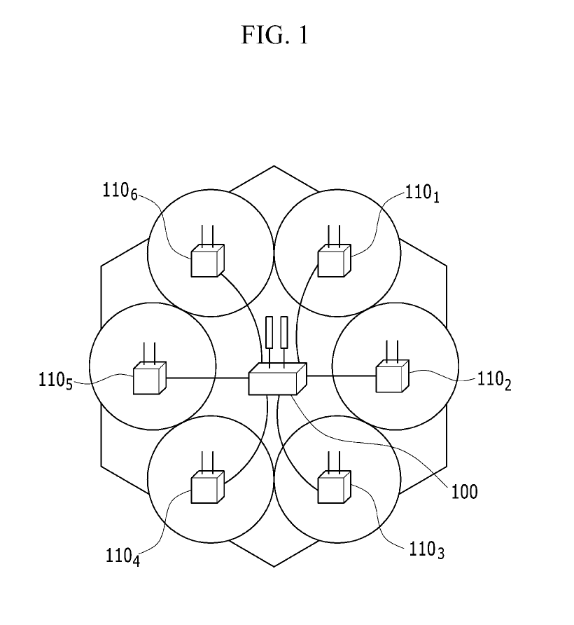

FIG. 1 is a diagram illustrating a distributed antenna system according to an exemplary embodiment of the present invention.

Referring to FIG. 1, a Distributed Antenna System (DAS) includes a base station 100 and a plurality of Remote Radio Heads (RRHs) 110₁-110₆.

The base station 100 manages a cell and supports wireless communication to a terminal within a cell. The base station 100 performs a baseband signal processing function and performs a control function of the RRHs 110₁-110₆ and a radio resource allocation function for transmitting and receiving to and from a terminal within a cell. A radio resource may include at least one of a time, a frequency, and a power resource.

The RRHs 110₁-110₆ are distributed within a cell that the base station 100 manages, and are connected to the base station 100 through an optic cable. The RRHs 110₁-110₆ may include at least one antenna.

According to an exemplary embodiment of the present invention, one base station 100 that is connected to the RRHs 110₁-110₆ forms a multiple input multiple output (MIMO) channel with a terminal within a cell, and when a plurality of terminals exist within a cell, the base station 100 may support multiple user MIMO (MU-MIMO) communication.

The MU-MIMO may include a downlink MU-MIMO and an uplink MU-MIMO. In the downlink MU-MIMO, one base station 100 performs transmission through the RRHs 110₁-110₆, and a plurality of terminals simultaneously perform reception. In the uplink MU-MIMO, a plurality of terminals performs transmission, and one base station 100 performs reception through the RRHs 110₁-110₆.

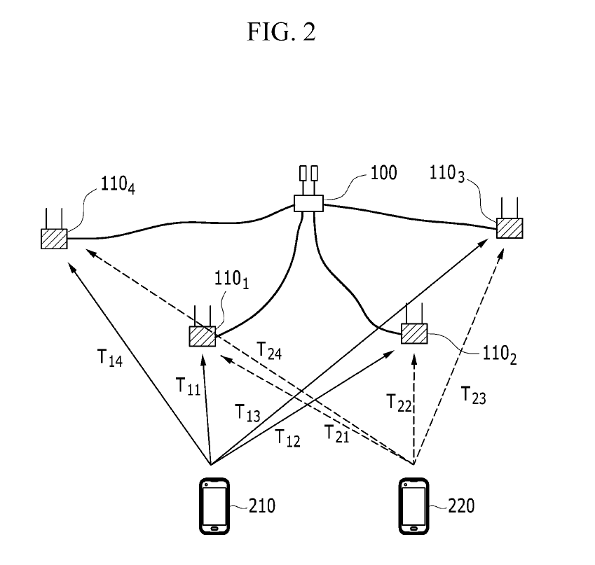

FIG. 2 is a diagram illustrating an uplink MU-MIMO according to an exemplary embodiment of the present invention.

Referring to FIG. 2, a cell that the base station 100 manages may include a plurality of terminals 210 and 220. The terminals 210 and 220 may include at least one antenna.

It is assumed that four RRHs 110₁-110₄ are distributed within a cell.

In uplink MU-MIMO transmission, the terminals 210 and 220 perform transmission, and the base station 100 that is connected to the RRHs 110₁-110₄ performs reception.

Each radio channel is formed between the terminals 210 and 220 and the RRH 110₁-110₄, and each radio channel has an independent delay time by spatial separation of the RRHs 110₁-110₄. That is, a signal that is transmitted from each of the terminals 210 and 220 has independent arrival delay times T₁₁, T₁₂, T₁₃, T₁₄, T₂₁, T₂₂, T₂₃, and T₂₄ through each radio channel and arrives at the RRHs 110₁-110₄. The arrival delay times T₁₁, T₁₂, T₁₃, T₁₄, T₂₁, T₂₂, T₂₃, and T₂₄ represent a time difference between a predetermined RRH reference time and an arrival time at each of the RRHs 110₁-110₄.

In uplink MU-MIMO transmission, different arrival delay times T₁₁, T₁₂, T₁₃, T₁₄, T₂₁, T₂₂, T₂₃, and T₂₄ between the terminals 210 and 220 and the RRHs 110₁-110₄ deteriorate receiving performance of an uplink MU-MIMO.

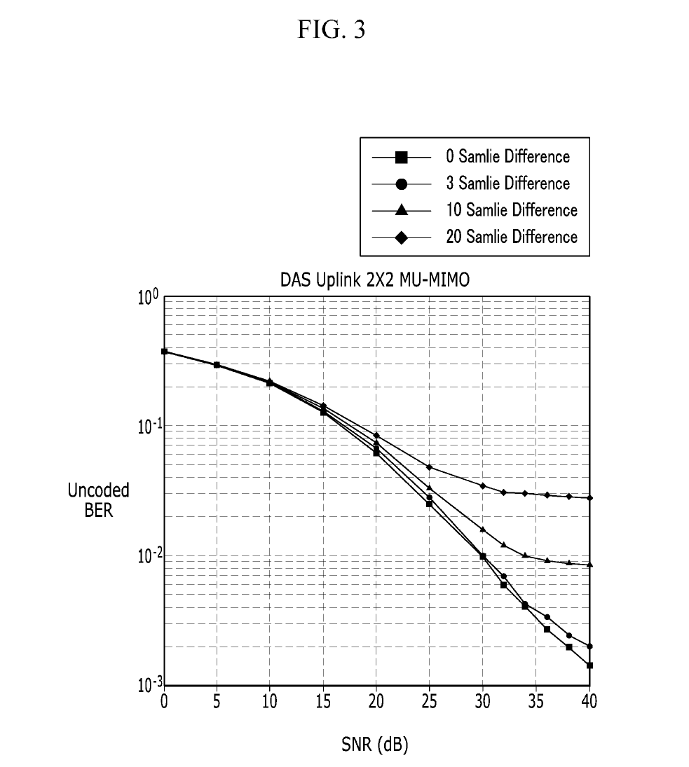

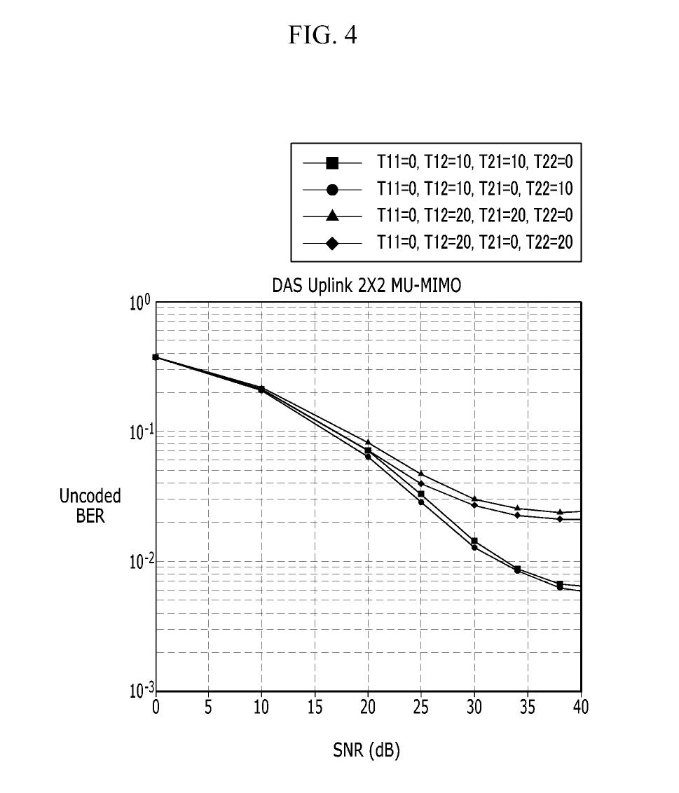

FIG. 3 is a graph illustrating a simulation result of a bit error rate (BER) to a signal-to-noise ratio (SNR) according to an arrival delay time difference between terminals and RRHs. FIG. 4 is a graph illustrating receiving performance according to a relative arrival delay time difference between terminals in each RRH.

FIGS. 3 and 4 illustrate an uplink 2*2 MU-MIMO scenario in which two terminals and two RRHs participate in an uplink MU-MIMO.

A simulation parameter that is applied to FIG. 3 is shown in Table 1. As shown in Table 1, in order to obtain receiving performance according to an arrival delay time difference, it is assumed that reception power is the same. In Table 1, BW represents a bandwidth.

TABLE 1

| Parameters | Assumption | |
|---|---|---|
| Delay Profile Model | Extended Pedestrian A model | |
| Maximum Dopller Frequency | 5 | Hz |
| Antenna Correlation | No Correlation | |
| BW | 20 | MHz |
| RB Size | 10 | Rb |
| QAM | 64 | QAM |

| | |
|---|---|
| Each UE Tx Antenna | 1 Tx Antenna |
| Each RRH Rx Antenna | 1Rx Antenna |
| Rx Recevier Power | Equal Power |
| Equalizer | MM5E |
| MU-MIMO Configuration | 2 × 2 MU-MIMO |
| | (2 UEs and multiple RRHs) |

In a simulation environment of Table 1, in each terminal, in order to view an influence of an arrival delay time difference between RRHs, while fixing arrival delay times T₁₁ and T₂₂ to 0 sample delay and changing each of arrival delay times T₁₂ and T₂₁ by samples 0, 3, 10, and 20, bit error rates according to an arrival delay time difference were compared.

As can be seen through a simulation result of FIG. 3, in each terminal, as an arrival delay time difference between RRHs increases, a bit error rate increases and thus it can be seen that degradation of receiving performance of uplink 2×2 MU-MIMOs occurs.

In FIG. 4, in order to view an influence of an arrival delay time difference between terminals in each RRH, it is assumed that T₁₁ arrives at sample times 0, 0, 0, and 0, T₁₂ is arrived at sample times 10, 10, 20, and 20, T₂₁ arrives at sample times 0, 10, 0, and 20, and T₂₂ arrives at sample times 0, 10, 0, and 20 in consideration of an arrival delay time difference of four cases.

In FIG. 4, in two cases, receiving performance according to a relative arrival delay time difference between terminals in each RRH is compared, T₁₁, T₁₂, T₁₂, and T₂₂ are 0, 0, 10, and 10, and 0, 10, 0, and 10, and T₁₁, T₁₂, T₁₂, and T₂₂ are 0, 0, 20, and 20, and 0, 20, 0, and 20. In a simulation environment of FIG. 3, a relative receiving delay time difference in which a signal that is transmitted from each terminal is received in RRHs is the same, but this is performed to know an influence that a relative receiving delay time difference between terminals in each RRH has in a receiving performance.

As shown in FIG. 4, even by a relative reception delay time difference between terminals in each RRH, it may be known that performance degradation occurs.

In a result of FIGS. 3 and 4, in uplink MU-MIMO transmission/reception of a distributed antenna system, it can be seen that a relative arrival delay time difference in which a signal that is transmitted from each terminal is received in spatially separated RRHs and a relative arrival delay time difference between terminals in each RRH have an influence on receiving performance of an uplink MU-MIMO of a distributed antenna system. Therefore, in consideration of such a relative arrival delay time difference, an RRH to participate in receiving an uplink MU-MIMO should be selected.

Therefore, in uplink MU-MIMO transmission/reception, in order to minimize receiving performance degradation of an uplink MU-MIMO due to an arrival delay time difference between the terminals 210 and 220 and the RRHs 110₁-110₄, in an exemplary embodiment of the present invention, a method of selecting RRHs to participate in receiving an uplink MU-MIMO among a plurality of RRHs according to a determined method and adjusting a transmitting time of the terminals 210 and 220 based on the selected RRHs is suggested.

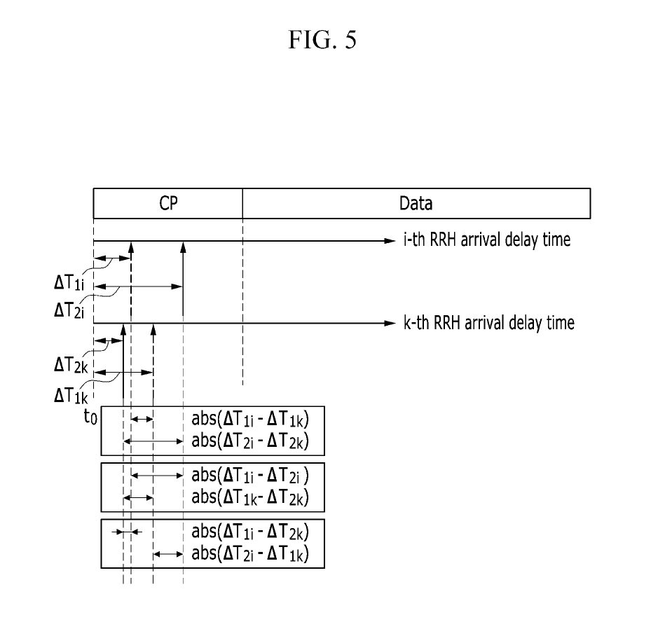

FIG. 5 is a diagram illustrating a kind of an arrival delay time difference in an uplink MU-MIMO according to an exemplary embodiment of the present invention.

In FIG. 5, ΔT indicates a time difference, i.e., an arrival delay time, between an RRH reference time and an RRH arrival time, and tₒ indicates an RRH reference time of an entire RRH. An arrival delay time in which a signal that is transmitted from an m-th terminal arrives at an n-th RRH is represented with ΔTₘₙ. When two terminals and two RRHs are assumed, as shown in FIG. 5, four arrival delay times ΔT₁ᵢ, ΔT₂ᵢ, ΔT₁ₖ, and ΔT₂ₖ are obtained, and an arrival delay time difference may be defined like abs (ΔTₘᵢ−ΔTₙₖ).

Three kinds of arrival delay time differences may exist. A first arrival delay time difference is an arrival delay time difference between the same terminal and different RRHs, a second arrival delay time difference is an arrival delay time difference between different terminals and the same RRH, and a third arrival delay time difference is an arrival delay time difference between different terminals and different RRHs. In this case, even if a predetermined RRH is selected by any rule, a value of the first arrival delay time difference is not changed. When a terminal adjusts a transmitting time of an uplink, the second and third arrival delay time differences may be changed.

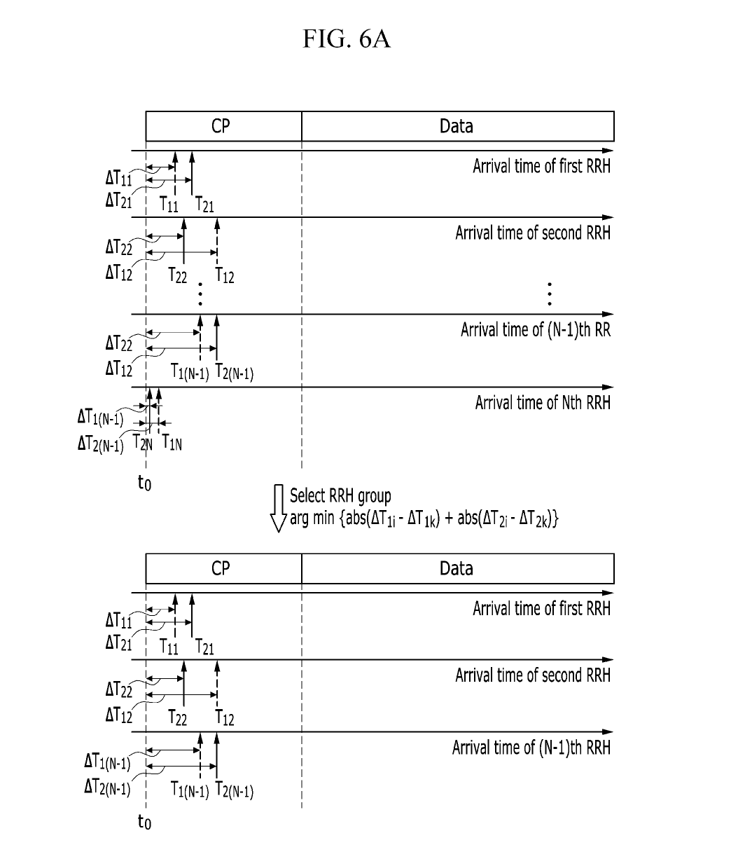

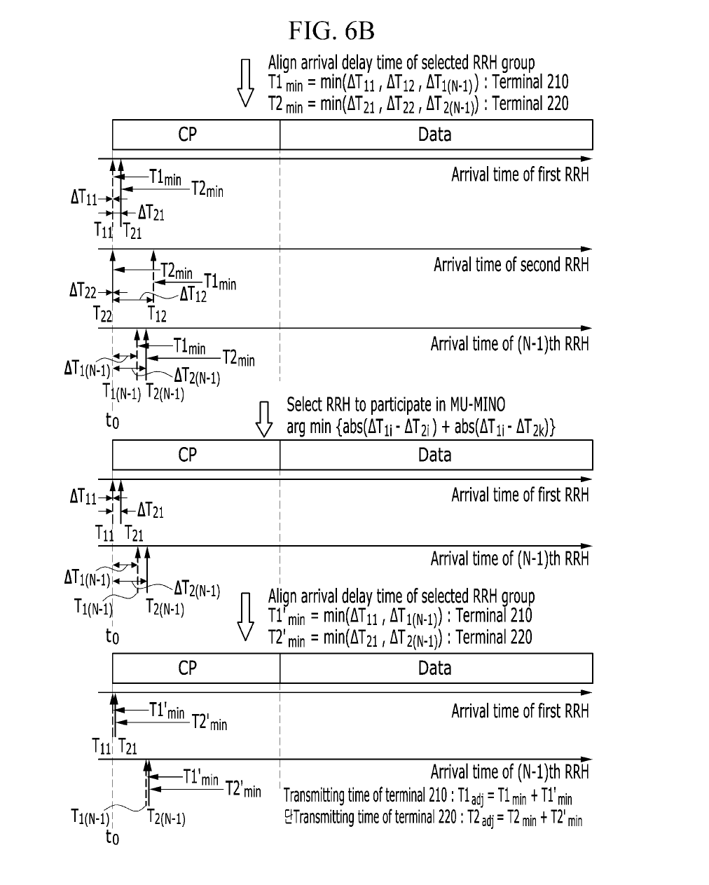

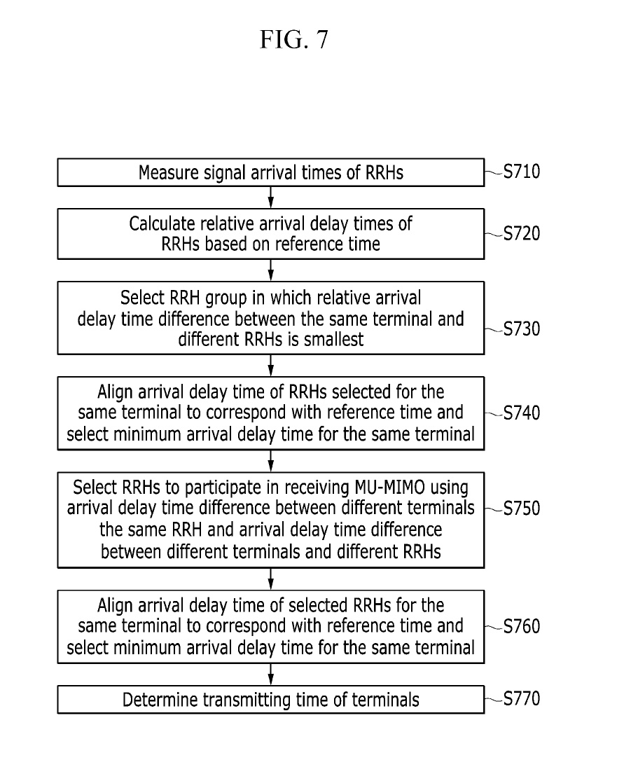

Hereinafter, a method of selecting an RRH to participate in receiving an uplink MU-MIMO for minimizing an arrival delay time difference and a method of adjusting a transmitting time of terminals will be described in detail with reference to FIGS. 6A, 6B, and 7. For convenience of description, uplink 2×2 MU-MIMOs are assumed, and it is assumed that terminals each have one transmitting antenna and that RRHs each have one receiving antenna.

FIGS. 6A and 6B are diagrams illustrating a method of selecting an RRH to participate in receiving an uplink MU-MIMO according to an exemplary embodiment of the present invention, and FIG. 7 is a flowchart illustrating a method of selecting an RRH to participate in receiving an uplink MU-MIMO and a method of adjusting a transmitting time of a terminal according to an exemplary embodiment of the present invention.

Referring to FIGS. 6A and 7, the terminals 210 and 220 transmit a training signal at a segment CP, and the N number of RRHs 110₁-110_{N} receive a training signal that is transmitted by the terminals 210 and 220 at a segment CP.

The base station 100 measures arrival times T₁₁, T₁₂, . . . , T_{1N}, T₂₁, T₂₂, . . . , T_{2N} in which the training signal is arrived at each of the RRHs 110₁-110_{N} (S710).

The base station 100 calculates arrival delay times ΔT₁₁, ΔT₁₂, . . . , ΔT_{1N}, ΔT₂₁, ΔT₂₂, . . . , ΔT_{2N} of the RRHs 110₁-110_{N} using a predetermined RRH reference time tₒ and arrival times T₁₁, T₁₂, . . . , T_{1N}, T₂₁, T₂₂, . . . , T_{2N} of the RRHs 110₁-110_{N} (S720).

The base station 100 selects an RRH group including the predetermined number of RRHs in which an arrival delay time difference between the same terminal and different RRHs is smallest, as in Equation 1 using arrival delay times ΔT₁₁, ΔT₁₂, . . . , ΔT_{1N}, ΔT₂₁, ΔT₂₂, . . . , ΔT_{2N} between the terminals 210 and 220 and the RRHs 110₁-110_{N} (S730). Here, the predetermined number may be set to the number or more of the terminals 210 and 220.

$${arg min}_{{i - th , k - th . RRH}_{i \neq k}} ( abs ( Δ {T}_{1 i} - Δ {T}_{1 k} ) + abs ( Δ {T}_{2 i} - Δ {T}_{2 k} ) ) \\ The number of operation = M ( N - 1 ) ! \qquad ( Equation 1 )$$

In Equation 1, M is the number of terminals, and in an exemplary embodiment of the present invention, M is 2.

Thereafter, referring to FIGS. 6B and 7, the base station 100 aligns an arrival delay time of RRHs that are selected at step S730 to correspond with a predetermined reference time, and selects a minimum arrival delay time among the aligned arrival delay times (S740). The base station 100 stores the aligned arrival delay time and the selected minimum arrival delay time for each terminal. For example, as shown in FIG. 6B, when the RRH that is selected at step S730 is a first RRH, a second RRH, and an (N−1)th RRH, a minimum arrival delay time may be selected, as in Equations 2 and 3.

T1ₘᵢₙ=min(ΔT₁₁,ΔT₁₂,ΔT_{1(N-1)}) (Equation 2)

T2ₘᵢₙ=min(τ₂₁,ΔT₂₂,ΔT_{2(N-1)}) (Equation 3)

The base station 100 selects RRHs to participate in receiving an MU-MIMO, as in Equation 4 using arrival delay times ΔT₁₁, ΔT₁₂, . . . , ΔT_{1N}, ΔT₂₁, ΔT₂₂, . . . , ΔT_{2N} between the terminals 210 and 220 and the RRHs 110₁-110_{N} (S750). That is, the base station 100 may select RRHs in which an arrival delay time difference between different terminals and the same RRH and an arrival delay time difference between different terminals and different RRHs becomes a minimum as an RRH to participate in receiving an MU-MIMO.

$${arg min}_{{i - th , k - th . RRH}_{i \neq k}} ( abs ( Δ {T}_{1 i} - Δ {T}_{1 k} ) + abs ( Δ {T}_{2 i} - Δ {T}_{2 k} ) ) \\ The number of operation = M ( N - 1 ) ! \qquad ( Equation 4 )$$

In Equation 4, M is the number of terminals, and in an exemplary embodiment of the present invention, M may be 2, and two RRHs, for example, a first RRH and an (N−1)th RRH, may be selected based on Equation 4.

The base station 100 aligns an arrival delay time of the RRH that is selected at step S750 to correspond with a predetermined reference time, and selects a minimum arrival delay time among aligned arrival delay times (S760). The base station 100 stores an aligned arrival delay time and a selected minimum arrival delay time for each terminal. For example, as shown in FIG. 6B, when the RRH that is selected at step S7530 is a first RRH and an (N−1)th RRH, a minimum arrival delay time may be selected as in Equations 5 and 6.

T1′ₘᵢₙ=min(ΔT₁₁,ΔT_{1(N-1)}) (Equation 5)

T2′ₘᵢₙ=min(ΔT₂₁,ΔT_{2(N-1)}) (Equation 6)

Finally, the base station 100 determines a transmitting time of the terminals 210 and 220, as in Equations 7 and 8 (S770). That is, the base station 100 may determine a transmitting time of the terminal 210 to the sum of minimum arrival delay times between the terminal 210 and RRHs that are calculated at each of steps S740 and S760, and determine a transmitting time of the terminal 220 to the sum of minimum arrival delay times between the terminal 220 and RRHs that are calculated at each of steps S740 and S760.

T1_{adj}=T1+ₘᵢₙ+T1′ₘᵢₙ (Equation 7)

In Equation 7, T1_{adj} represents a transmitting time of the terminal 210.

T2_{adj}=T2ₘᵢₙ+T2′ₘᵢₙ (Equation 8)

In Equation 8, T2_{adj} represents a transmitting time of the terminal 220.

Through the above procedure, the base station 100 selects an RRH to participate in receiving an MU-MIMO and adjusts a transmitting time of each of the terminals 210 and 220, thereby minimizing an arrival delay time difference between the terminals 210 and 220 and the selected RRH, as shown in FIG. 6B, and improving a receiving performance gain of the MU-MIMO.

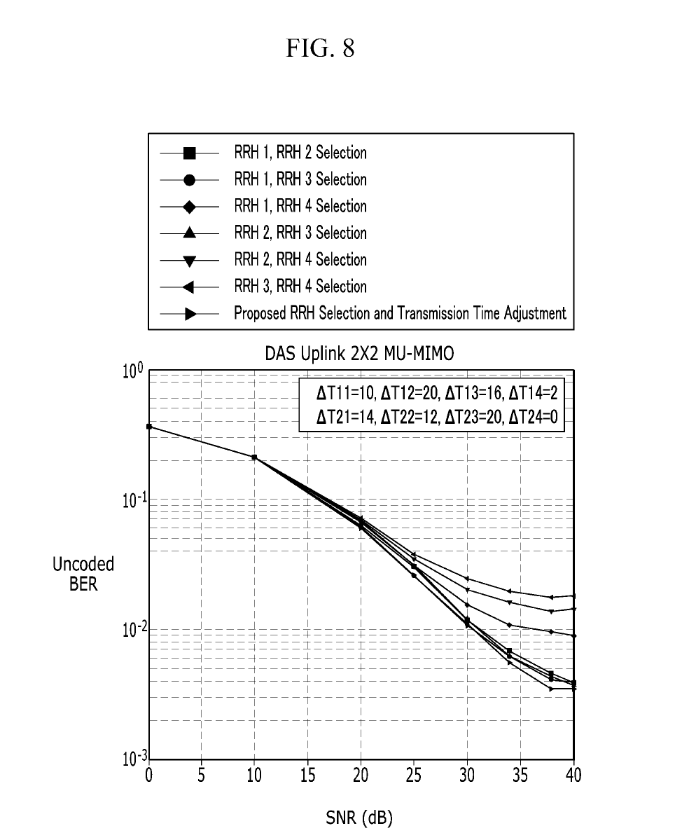

FIG. 8 is a graph illustrating receiving performance of an uplink MU-MIMO by a method of selecting an RRH and a method of adjusting a transmitting time of a terminal according to an exemplary embodiment of the present invention.

FIG. 8 illustrates uplink 2*2 MU-MIMO transmission/reception in a DAS environment that is formed with four RRHs, i.e., RRH1, RRH2, RRH3, and RRH4, and two terminals, and arrival delay times ΔT₁₁, ΔT₁₂, . . . , ΔT₁₄, ΔT₂₁, ΔT₂₂, ΔT₂₄ of RRH1, RRH2, RRH3, and RRH4 are shown in FIG. 8.

A simulation parameter that is applied to FIG. 8 is represented in Table 1.

As a simulation result of a BER to an SNR of a case of randomly selecting two RRHs among RRH1, RRH2, RRH3, and RRH4 and of a case of selecting two RRHs with reference to FIGS. 6A, 6B, and 7, as shown in FIG. 8, by performing a method of selecting an RRH and a method of adjusting a transmitting time of a terminal according to an exemplary embodiment of the present invention, better receiving performance gain can be obtained, compared with a case of randomly selecting two RRHs.

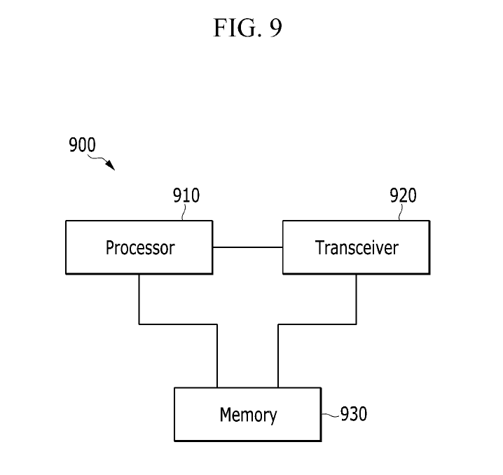

FIG. 9 is a block diagram illustrating a configuration of a communication apparatus of a base station according to an exemplary embodiment of the present invention.

Referring to FIG. 9, a communication apparatus 900 of a base station includes a processor 910, a transceiver 920, and a memory 930.

By performing operations that are described with reference to FIGS. 6A, 6B, and 7, the processor 910 selects RRHs to participate in receiving an uplink MU-MIMO and determines a transmitting time adjusting value of the terminals 210 and 220.

The transceiver 920 receives a training signal from the terminals 210 and 220. Such a transceiver 920 may include a plurality of RRHs that are described with reference to FIGS. 1 and 2. The transceiver 920 may transmit each of transmitting time adjusting values of the terminals 210 and 220 to the terminals 210 and 220.

The memory 930 stores instructions for performing in the processor 910 or loads and temporarily stores an instruction from a storage device (not shown), and the processor 910 executes an instruction that is stored or loaded at the memory 930.

The processor 910 and the memory 930 are connected through a bus (not shown), and an input/output interface (not shown) may be connected to the bus. In this case, the transceiver 920 is connected to the input/output interface, and a peripheral device such as an input device, a display, a speaker, and a storage device may be connected to the input/output interface.

According to an exemplary embodiment of the present invention, in uplink MU-MIMO communication of a distributed antenna system, by selecting an RRH to participate in receiving an uplink MU-MIMO in consideration of a relative receiving delay time difference between a plurality of terminals and a plurality of RRHs and by adjusting a transmitting time of terminals based on the selected RRH, a receiving performance gain of the uplink MU-MIMO can be improved.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a base station that is connected to a plurality of Remote Radio Heads (RRH) that are installed within a cell performs uplink multiple user-multiple input multiple output (MU-MIMO) communication with a plurality of terminals, the method comprising:
acquiring an arrival time at which a signal that is transmitted from the plurality of terminals arrives at the plurality of RRHs;
calculating an arrival delay time between the plurality of terminals and the plurality of RRHs using a predetermined reference time and an arrival time of the plurality of RRHs;
selecting RRHs to participate in receiving the uplink MU-MIMO among the plurality of RRHs using an arrival delay time between the plurality of terminals and the plurality of RRHs; and
adjusting a transmitting time of the plurality of terminals using an arrival delay time between the plurality of terminals and RRHs to participate in receiving the uplink MU-MIMO.

2. The method of claim 1, wherein the selecting of RRHs comprises:
calculating a plurality of first arrival delay time differences between the same terminal and different RRHs using an arrival delay time between the plurality of terminals and the plurality of RRHs;
selecting a first number of RRHs among the plurality of first arrival delay time differences;
calculating a plurality of second arrival delay time differences between different terminals and the same RRH and a plurality of third arrival delay time differences between different terminals and different RRHs using an arrival delay time between the plurality of terminals and the first number of RRHs; and
selecting a second number of RRHs to participate in receiving the uplink MU-MIMO using the plurality of second arrival delay time differences and the plurality of third arrival delay time differences.

3. The method of claim 2, wherein the selecting of the first number of RRHs comprises selecting the first number of RRHs having a small value among the plurality of first arrival delay time differences.

4. The method of claim 2, wherein the selecting of the second number of RRHs comprises selecting the second number of RRHs in which the sum of a second arrival delay time difference and a third arrival delay time difference is small for each of the first number of RRHs.

5. The method of claim 2, wherein the adjusting of a transmitting time comprises:
calculating a first minimum arrival delay time between the first number of RRHs for each terminal using an arrival delay time between the same terminal and the first number of selected RRHs;
calculating a second minimum arrival delay time between the second number of RRHs for each terminal using an arrival delay time between the same terminal and the second number of selected RRHs; and
determining a transmitting time of each terminal using the calculated first minimum arrival time for each terminal and the calculated second minimum arrival delay time for each terminal.

6. The method of claim 5, wherein the determining of a transmitting time comprises determining a transmitting time of each terminal from the sum of a first minimum arrival time corresponding to each terminal and a second minimum arrival time corresponding to each terminal.

7. The method of claim 5, wherein the adjusting of a transmitting time further comprises transmitting a transmitting time of each terminal to each terminal.

8. An apparatus that enables a base station that is connected to a plurality of Remote Radio Heads (RRH) that are installed within a cell to perform uplink multiple user-multiple input multiple output (MU-MIMO) communication with a plurality of terminals, the apparatus comprising:
a processor that acquires an arrival time at which a signal that is transmitted from the plurality of terminals arrives at the plurality of RRHs and that calculates an arrival delay time between the plurality of terminals and the plurality of RRHs using a predetermined reference time and an arrival time of the plurality of RRHs and that selects RRHs to participate in receiving an uplink MU-MIMO using an arrival delay time between the plurality of terminals and the plurality of RRHs; and
a transceiver comprising the plurality of RRHs and that receives a signal that is transmitted from the plurality of terminals through the plurality of RRHs.

9. The apparatus of claim 8, wherein the processor calculates a plurality of first arrival delay time differences between the same terminal and different RRHs using an arrival delay time between the plurality of terminals and the plurality of RRHs to select a first number of RRHs, and calculates a plurality of second arrival delay time differences between different terminals and the same RRH and a plurality of third arrival delay time differences between different terminals and different RRHs using an arrival delay time between the plurality of terminals and the first number of RRHs to select a second number of RRHs to participate in receiving the uplink MU-MIMO.

10. The apparatus of claim 9, wherein the processor selects the first number of RRHs having a small value among a plurality of first arrival delay time differences.

11. The apparatus of claim 9, wherein the processor selects the second number of RRHs in which the sum of a second arrival delay time difference and a third arrival delay time difference is small for each of the first number of RRHs.

12. The apparatus of claim 9, wherein the processor determines a transmitting time of the plurality of terminals using an arrival delay time between the plurality of terminals and RRHs to participate in receiving the uplink MU-MIMO.

13. The apparatus of claim 12, wherein the processor calculates a first minimum arrival delay time between the first number of RRHs for each terminal using an arrival delay time between the same terminal and the first number of selected RRHs, calculates a second minimum arrival delay time between the second number of RRHs for each terminal using an arrival delay time between the same terminal and the second number of selected RRHs, and determines a transmitting time of each terminal using the calculated first minimum arrival time for each terminal and using the calculated second minimum arrival time for each terminal.

14. The apparatus of claim 13, wherein the processor determines a transmitting time of each terminal from the sum of a first minimum arrival time corresponding to each terminal and a second minimum arrival time corresponding to each terminal.
